(19) United States
(12) Patent Application Publication
(10) Pub. No.: US 2026/0181656 A1
(43) Pub. Date: Jun. 25, 2026

(54) Triggering User Equipment Buffer Status Reporting for XR Services

(71) Applicant: Telefonaktiebolaget LM Ericsson (publ), Stockholm (SE)

(72) Inventors: Richard Tano, Stockholm (SE); Jose Luis Pradas, Stockholm (SE); Du Ho Kang, Sollentuna (SE)

(21) Appl. No.: 19/129,112

(22) PCT Filed: Nov. 13, 2023
(86) PCT No.: PCT/EP2023/081599

§ 371 Date: May 12, 2025

Related U.S. Application Data
(60) Provisional application No. 63/425,000, filed on Nov. 14, 2022.

(51) Int. Cl. H04W 72/23; H04W 28/02; H04W 28/06; H04W 72/21

(52) U.S. Cl. CPC H04W 72/23; H04W 28/0278; H04W 28/06; H04W 72/21

(57) ABSTRACT

Embodiments include methods for a user equipment (UE) configured to transmit application data to a radio access network (RAN) node. Such methods include buffering data generated by an application hosted by the UE. The buffered data comprises a plurality of sets of protocol data units (PDUs). Such methods include transmitting a buffer status report (BSR) to the RAN node in response to one or more of the following conditions at the UE: at least one of the buffered PDU sets has a remaining packet delay budget (PDBrem) that is less than a first threshold, where PDBrem for a PDU set decreases in proportion to a duration that the PDU set has been buffered; and at least one of the buffered PDU sets is discarded by the UE. Other embodiments include complementary methods for a RAN node, as well as UEs and RAN nodes configured to perform such methods.

### TECHNICAL FIELD

The present disclosure relates generally to wireless communication networks, and more specifically to techniques for wireless devices to report about buffered data associated with applications needing guaranteed low latency, such as extended reality (XR) and cloud gaming.

### BACKGROUND

Currently the fifth generation (5G) of cellular is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces. The 5GC can include various other network functions (NFs), such as Session Management Function(s) (SMF).

In addition, the gNBs can be connected to each other via one or more Xn interfaces, such as Xn interface (140) between gNBs (100, 150). The radio technology for the NG-RAN is often referred to as “New Radio” (NR). With respect to the NR interface to user equipment (UEs), each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells. In general, a DL “beam” is a coverage area of a network-transmitted reference signal (RS) that may be measured or monitored by a UE.

NG RAN logical nodes (e.g., gNB 100) may include a Central Unit (CU or gNB-CU, e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions. Each CU and DU can include various circuitry needed to perform their respective functions, including processing circuitry, communication interface circuitry (e.g., transceivers), and power supply circuitry.

A gNB-CU connects to one or more gNB-DUs over respective F1 logical interfaces (e.g., 122 and 132 shown in FIG. 1). However, a gNB-DU can be connected to only a single gNB-CU. The gNB-CU and its connected gNB-DU(s) are only visible to other gNBs and the 5GC as a gNB. In other words, the F1 interface is not visible beyond gNB-CU.

FIG. 2 shows another high-level view of an exemplary 5G network architecture, including an NG-RAN (299) and a 5GC (298). As shown in the figure, the NG-RAN can include gNBs (e.g., 210a,b) and ng-eNBs (e.g., 220a,b) that are interconnected with each other via respective Xn interfaces. An ng-eNB is similar to a fourth generation (4G) Long-Term Evolution (LTE) eNB, except that it supports the Xn and NG interfaces rather than corresponding X2 and S1 interfaces.

The gNBs and ng-eNBs are also connected via the NG interfaces to the 5GC, more specifically to AMFs (e.g., 230a,b) via respective NG-C interfaces and to UPFs (e.g., 240a,b) via respective NG-U interfaces. Moreover, the AMFs can communicate with one or more policy control functions (PCFs, e.g., 250a,b) and network exposure functions (NEFs, e.g., 260a,b).

Each of the gNBs can support the NR radio interface including frequency division duplexing (FDD), time division duplexing (TDD), or a combination thereof. Each of ng-eNBs can support the 4G/LTE radio interface. Each of the gNBs and ng-eNBs can serve a geographic coverage area including one or more cells (e.g., 211a-b and 221a-b). Depending on the cell in which it is located, UEs (e.g., 205) can communicate with the gNB or ng-eNB serving that cell via the NR or LTE radio interface, respectively. Although FIG. 2 shows gNBs and ng-eNBs separately, it is also possible that a single NG-RAN node provides both LTE and NR functionality.

To support communication from UE to RAN, a UE reports status of its buffers containing data awaiting UL transmission to the RAN. The UE reports this information in a medium access control (MAC) message called a buffer status report (BSR). The following BSR formats are used by UEs depending on various factors:
Short BSR format (fixed size),
Short Truncated BSR format (fixed size),
Long Truncated BSR format (variable size), and
Long BSR format (variable size).
   After receiving a BSR, a RAN node can adjust scheduling of UE UL transmissions accordingly.

Extended Reality (XR) and cloud gaming are some of the most important 5G media applications under consideration. XR is an umbrella term that refers to all real-and-virtual combined environments and human-machine interactions generated by computer technology and wearables. It includes exemplary forms such as Augmented Reality (AR), Mixed Reality (MR), and Virtual Reality (VR), as well as various other types that span or sit between these examples. In the following, the term “XR” also refers to cloud gaming and related applications. In general, XR services require relatively high throughput (e.g., bit rates) and a latency that is relatively low and bounded, compared to certain other services.

3GPP Rel-17 included a study item on XR Evaluations for NR, with the main objectives being to identify the traffic model for each application of interest, the evaluation methodology and the key performance indicators of interest for relevant deployment scenarios, and to carry out performance evaluations to investigate possible standardization enhancements in follow-up study or work items in Rel-18.

### SUMMARY

During Rel-18 work, 3GPP identified that the current UE BSR mechanism is inadequate for XR services. For example, to address the bounded latency and bit rate requirements of XR traffic, the RAN needs to receive more precise buffer status information and timing information from UEs. Although new XR-related BSRs may be able to provide such information, it is unclear how these new BSR reports can be triggered at the UE so they reach the RAN at the appropriate time (i.e., when needed by the RAN). Current BSR triggers are neither suitable nor sufficient to fulfill BSR requirements for XR services. Given the importance of XR services, improvements are needed to address these problems, issues, and/or difficulties.

An object of embodiments of the present disclosure is to improve communication between UEs and RAN nodes, such as by providing, enabling, and/or facilitating solutions to exemplary problems summarized above and described in more detail below.

Some embodiments include methods (e.g., procedures) for a UE configured to transmit application data to a RAN node (e.g., gNB).

These exemplary methods include buffering data generated by an application hosted by the UE. The buffered data comprises a plurality of sets of protocol data units (PDUs). These exemplary methods also include transmitting a BSR to the RAN node in response to one or more of the following conditions at the UE:
at least one of the buffered PDU sets has a remaining packet delay budget (PDBᵣₑₘ) that is less than a first threshold, wherein PDBᵣₑₘ for a PDU set decreases in proportion to a duration that the PDU set has been buffered; and
at least one of the buffered PDU sets discarded by the UE.

In some embodiments, the transmitted BSR indicates an amount of data corresponding to buffered PDU sets that meet the one or more conditions at the UE. In some embodiments, these exemplary methods also include receiving a BSR configuration from the RAN node. The BSR configuration includes a value for the first threshold. In some embodiments, buffering data includes assigning each of the PDU sets, upon buffering, to one of a plurality of available PDB buckets associated with respective ranges of PDBᵣₑₘ. In some of these embodiments, the first threshold corresponds to one or more PDB buckets that are associated with one or more lowest ranges of PDBᵣₑₘ.

In some embodiments, the BSR is also transmitted to the RAN node in response to any of the following conditions at the UE:
a number or total size of buffered PDU sets with PDBᵣₑₘ greater than a second threshold is at least a third threshold;
a number or total size of buffered PDU sets with PDBᵣₑₘ that change from greater than to less than a fourth threshold, is at least a fifth threshold;
a number or total size of buffered PDU sets that are overdue is at least an sixth threshold;
a number or total size of buffered PDU sets changes by at least a seventh threshold; and
an explicit indication received from the RAN node.

In some of these embodiments, these exemplary methods also include adjusting the PDB bucket assignment of each of the PDUs that remains buffered after a time period, according to their respective PDBᵣₑₘ. For example, the PDB bucket assignments can be adjusted periodically or in response to certain events, such as buffering of a newly available PDU set. The fourth threshold corresponds to a boundary between two PDB buckets associated with adjacent ranges of PDBᵣₑₘ.

In some of these embodiments, when the explicit indication is received from the RAN node, the BSR is transmitted to the RAN node even when no data generated by the application is currently buffered. In some of these embodiments, each of the third, fifth, sixth, and seventh thresholds is one of the following: a single PDU set, a plurality (N) of PDU sets, or a number of kilobytes.

In some embodiments, these exemplary methods also include initiating a prohibit timer in association with transmitting the BSR and refraining from transmitting another BSR until expiration of the prohibit timer, even when one of the conditions occurs while the prohibit timer is running.

In some embodiments, these exemplary methods also include receiving from the RAN node a grant of uplink resources based on the transmitted BSR, and transmitting at least a portion of the buffered data to the RAN node, using the granted uplink resources.

Other embodiments include exemplary methods (e.g., procedures) for a RAN node (e.g., gNB) configured to receive application data from a UE. These embodiments are generally complementary to UE embodiments summarized above.

These exemplary methods include receiving from the UE a BSR pertaining to buffered data generated by an application hosted by the UE. The buffered data comprises a plurality of sets of PDUs. Moreover, the BSR is received in response to one or more of the following conditions at the UE:
at least one of the buffered PDU sets has a remaining packet delay budget (PDBᵣₑₘ) that is less than a first threshold, wherein PDBᵣₑₘ for a PDU set decreases in proportion to a duration that the PDU set has been buffered; and
at least one of the buffered PDU sets is discarded by the UE.

In some embodiments, the received BSR indicates an amount of data corresponding to buffered PDU sets that meet the one or more conditions at the UE. In some embodiments, these exemplary methods also include transmitting a BSR configuration to the UE. The BSR configuration includes a value for the first threshold.

In some embodiments, each of the PDU sets is assigned by the UE, upon buffering, to one of a plurality of available PDB buckets associated with respective ranges of PDBᵣₑₘ. In some of these embodiments, the first threshold corresponds to one or more PDB buckets that are associated with one or more lowest ranges of PDBᵣₑₘ.

In some of these embodiments, the BSR is also received from the UE in response any of the following conditions at the UE:
a number or total size of buffered PDU sets with PDBᵣₑₘ greater than a second threshold is at least a third threshold;
a number or total size of buffered PDU sets with PDBᵣₑₘ that change from greater than to less than a fourth threshold, is at least a fifth threshold;
a number or total size of buffered PDU sets that are overdue is at least an sixth threshold;
a number or total size of buffered PDU sets changes by at least a seventh threshold; and
an explicit indication received from the RAN node.

In some of these embodiments, the PDB bucket assignments of the PDU sets that remain buffered after a time period are adjusted by the UE according to their respective PDBᵣₑₘ. For example, the PDB bucket assignments can be adjusted periodically or in response to certain events, such as buffering of a newly available PDU set. The fourth corresponds to a boundary between two PDB buckets associated with adjacent ranges of PDBᵣₑₘ.

In some of these embodiments, when the explicit indication is sent to the UE, the BSR is received from the UE even when no data generated by the application is currently buffered at the UE. In some of these embodiments, each of the third, fifth, sixth, and seventh thresholds is one of the following: a single PDU set, a plurality (N) of PDU sets, or a number of kilobytes.

In some embodiments, these exemplary methods also include transmitting to the UE a grant of uplink resources based on the received BSR and receiving at least a portion of the buffered data from the UE, using the granted uplink resources.

In various embodiments summarized above, the application is an XR application and the data generated by the application has a bounded latency requirement.

Other embodiments include UEs (e.g., wireless devices) and RAN nodes (e.g., base stations, eNBs, gNBs, ng-eNBs, etc., or components thereof) configured to perform operations corresponding to any of the exemplary methods described herein. Other embodiments include non-transitory, computer-readable media storing program instructions that, when executed by processing circuitry, configure such UEs or RAN nodes to perform operations corresponding to any of the exemplary methods described herein.

These and other embodiments described herein may trigger timely UE BSRs to the RAN, which may enable the RAN to provide timely UL resource grants that support transmission of buffered XR data in a manner that meets bounded latency requirements. Moreover, embodiments may facilitate RAN configuration of such BSR triggers, thereby giving the RAN control over UE BSRs. At a high level, embodiments may facilitate delivery of XR services via wireless networks (e.g., RANs).

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 illustrate two high-level views of an exemplary 5G/NR network architecture.

FIG. 3 shows an exemplary configuration of NR user plane (UP) and control plane (CP) protocol stacks.

FIG. 4 illustrates a comparison of various characteristics or requirements between Extended Reality (XR) and other 5G applications.

FIG. 5 shows an example of frame latency measured over a RAN (e.g., NG-RAN).

FIG. 6 shows exemplary cumulative distribution functions (CDFs) for the number of transport blocks (TBs) on the NR PHY required to deliver video frames of various sizes.

FIG. 7 shows a comparison of arrival times between XR, voice-over-IP (VOIP), and web browsing traffic.

FIGS. 8A-B show two exemplary buffer status report (BSR) formats.

FIG. 9 shows an exemplary arrangement in which UE-buffered PDUs are classified based on remaining packet delay budget, according to various embodiments of the present disclosure.

FIG. 10 shows a flow diagram of an exemplary method for a UE (e.g., wireless device), according to various embodiments of the present disclosure.

FIG. 11 shows a flow diagram of an exemplary method for a RAN node (e.g., base station, eNB, gNB, ng-eNB, etc.), according to various embodiments of the present disclosure.

FIG. 12 shows a communication system according to various embodiments of the present disclosure.

FIG. 13 shows a UE according to various embodiments of the present disclosure.

FIG. 14 shows a network node according to various embodiments of the present disclosure.

FIG. 15 shows host computing system according to various embodiments of the present disclosure.

FIG. 16 is a block diagram of a virtualization environment in which functions implemented by some embodiments of the present disclosure may be virtualized.

FIG. 17 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system and can be applied to any communication system that may benefit from them. 5G/NR technology shares many similarities with fourth-generation LTE. For example, NR uses CP-OFDM (Cyclic Prefix Orthogonal Frequency Division Multiplexing) in the DL and both CP-OFDM and DFT-spread OFDM (DFT-S-OFDM) in the UL. As another example, in the time domain, NR DL and UL physical resources are organized into equal-sized 1-ms subframes. A subframe is further divided into multiple slots of equal duration, with each slot including multiple OFDM-based symbols. An NR slot can include 14 OFDM symbols for normal cyclic prefix and 12 symbols for extended cyclic prefix. A resource block (RB) consists of a group of 12 contiguous OFDM subcarriers for a duration of a 12- or 14-symbol slot. A resource element (RE) corresponds to one OFDM subcarrier during one OFDM symbol interval.

In 3GPP Release-15 (Rel-15), an NR UE can be configured with up to four carrier bandwidth parts (BWPs) in the DL with a single DL BWP being active at a given time. A UE can be configured with up to four BWPs in the UL with a single UL BWP being active at a given time. If a UE is configured with a supplementary UL (SUL), the UE can be configured with up to four additional BWPs in the SUL, with a single SUL BWP being active at any time.

Common RBs (CRBs) are numbered from 0 to the end of the carrier bandwidth. Each BWP configured for a UE has a common reference of CRB0, such that a configured BWP may start at a CRB greater than zero. CRB0 can be identified by one of the following parameters provided by the network, as further defined in 3GPP TS 38.211 section 4.4:
PRB-index-DL-common for DL in a primary cell (PCell, e.g., PCell or PSCell);
PRB-index-UL-common for UL in a PCell;
PRB-index-DL-Dedicated for DL in a secondary cell (SCell);
PRB-index-UL-Dedicated for UL in an SCell; and
PRB-index-SUL-common for a supplementary UL.

In this manner, a UE can be configured with a narrow BWP (e.g., 10 MHz) and a wide BWP (e.g., 100 MHz), each starting at a particular CRB, but only one BWP can be active for the UE at a given point in time. Within a BWP, PRBs are defined and numbered in the frequency domain from 0 to

$${N}_{BWP , i}^{size} - 1 ,$$

where i is the index of the particular BWP for the carrier.

NR supports various SCS values Δf=(15×2^{μ}) kHz, where μ∈(0, 1, 2, 3, 4) are referred to as “numerologies.” Numerology μ=0 (i.e., Δf=15 kHz) provides the basic (or reference) SCS that is also used in LTE. The symbol duration, cyclic prefix (CP) duration, and slot duration are inversely related to SCS or numerology. For example, there is one (1-ms) slot per subframe for Δf=15 kHz, two 0.5-ms slots per subframe for Δf=30 kHz, etc. In addition, the maximum carrier bandwidth is directly related to numerology according to 2^{μ}*50 MHz. Table 1 below summarizes the supported NR numerologies and associated parameters. Different DL and UL numerologies can be configured by the network.

TABLE 1

| | Δf = 2^{μ} · | Cyclic | CP | Symbol | | Symbol + | | Slot | | Max carrier |
|---|---|---|---|---|---|---|---|---|---|---|
| μ | 15 (kHz) | prefix (CP) | duration | duration | | CP | | duration | | BW |
| 0 | 15 | Normal | 4.69 μs | 66.67 | μs | 71.35 | μs | 1 | ms | 50 MHz |
| 1 | 30 | Normal | 2.34 μs | 33.33 | μs | 35.68 | μs | 0.5 | ms | 100 MHz |
| 2 | 60 | Normal, | 1.17 μs | 16.67 | μs | 17.84 | μs | 0.25 | ms | 200 MHz |
| | | Extended | | | | | | | | |
| 3 | 120 | Normal | 0.59 μs | 8.33 | μs | 8.92 | μs | 125 | μs | 400 MHz |
| 4 | 240 | Normal | 0.29 μs | 4.17 | μs | 4.46 | μs | 62.5 | μs | 800 MHz |

In addition to providing coverage via cells as in LTE, NR networks also provide coverage via “beams.” In general, a downlink (DL, i.e., network to UE) “beam” is a coverage area of a network-transmitted reference signal (RS) that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DM-RS, PTRS) are associated with specific UEs that have a network connection.

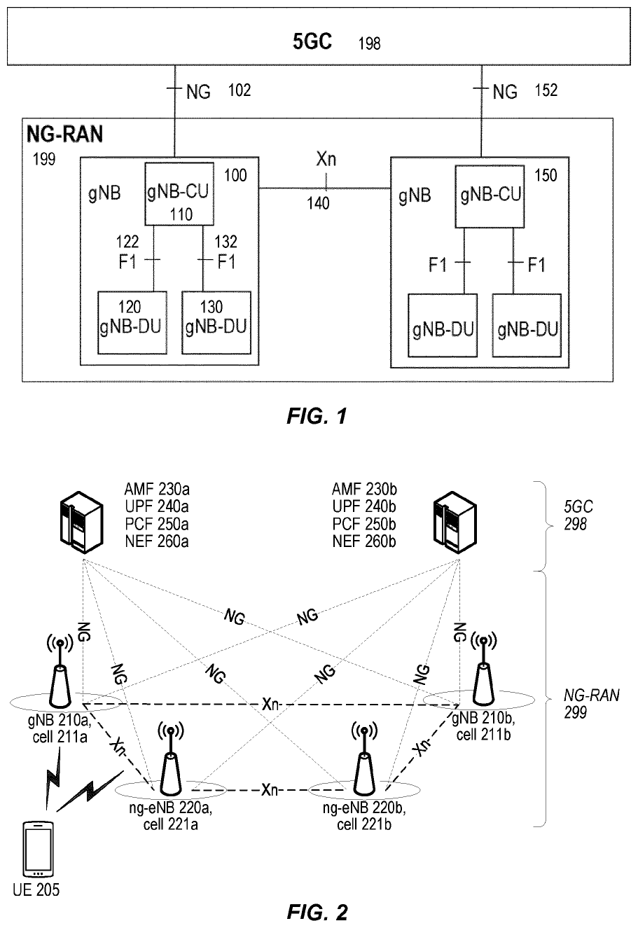

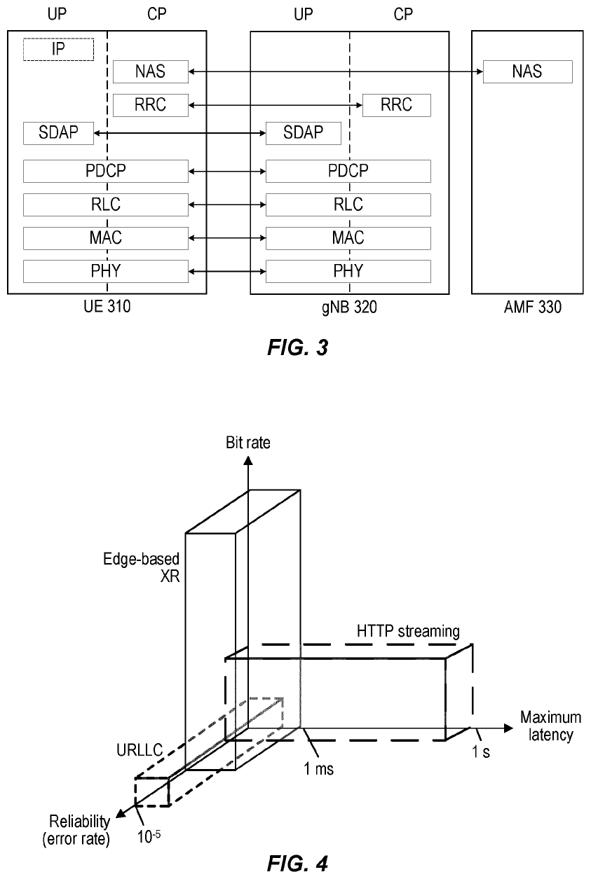

FIG. 3 shows an exemplary configuration of NR user plane (UP) and control plane (CP) protocol stacks between a UE (310), a gNB (320), and an AMF (330), such as those shown in FIGS. 1-2. The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to PDCP as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets.

When each IP packet arrives, PDCP starts a discard timer. When this timer expires, PDCP discards the associated SDU and the corresponding PDU. If the PDU was delivered to RLC, PDCP also indicates the discard to RLC. The RLC layer transfers PDCP PDUs to the MAC through logical channels (LCH). RLC provides error detection/correction, concatenation, segmentation/reassembly, sequence numbering, reordering of data transferred to/from the upper layers. If RLC receives a discard indication from associated with a PDCP PDU, it will discard the corresponding RLC SDU (or any segment thereof) if it has not been sent to lower layers.

MAC provides mapping between LCHs and PHY transport channels, LCH prioritization, multiplexing into or demultiplexing from transport blocks (TBs), hybrid ARQ (HARQ) error correction, and dynamic scheduling (in gNB). PHY provides transport channel services to MAC and handles transfer over the NR radio interface, e.g., via modulation, coding, antenna mapping, and beam forming.

On the CP side, the non-access stratum (NAS) layer between UE and AMF handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

5G/NR is designed to support applications demanding high rate and low latency in line with the requirements for supporting XR and cloud gaming applications. 3GPP Rel-17 includes a study item (SI) on XR Evaluations for NR. The main objectives are to identify the traffic model for each application of interest and the evaluation methodology and the key performance indicators of interest for relevant deployment scenarios, and to carry out performance evaluations accordingly in order to investigate possible standardization enhancements in potential follow-up SI or work item (WI).

Edge Computing (EC) can be a network architecture enabler for XR. In general, EC facilitates deployment of cloud computing capabilities and service environments close to the cellular radio access network (RAN). It can provide benefits such as lower latency and higher bandwidth for user-plane (UP, e.g., data) traffic, as well as reduced backhaul traffic to the 5G core network (5GC). 3GPP is also studying prospects for several new services on application architecture for enabling Edge Applications, as further described in 3GPP TR 23.758 (v17.0.0).

FIG. 4 illustrates a high-level comparison of various characteristics requirements for XR and other 5G applications. In particular, FIG. 4 shows a comparison of latency, reliability, and data rate requirements for URLLC, streaming, and EC-based XR. While URLLC services have extreme requirements of 1-ms latency and of 10⁻⁵, EC-based XR can have relaxed requirements of 5-10 ms latency and 10⁻⁴ reliability. However, XR services can require a much higher bite rate than either URLLC or streaming. (e.g., due to codec inefficiency). XR traffic can also be very dynamic, e.g., due to eye/viewport tracking.

XR requires bounded latency but not necessarily ultra-low latency. However, the end-to-end latency (or packet delay) budget (e.g., 20-80 ms) must be distributed over several components including application processing latency, transport latency, radio link latency, etc. For these applications, short transmission time intervals (TTIs) or mini slots may not be effective.

In general, XR traffic is relatively periodic in arrival time but average data rate requirement and dominant transmission direction (e.g., UL or DL) is dependent on the particular XR-related service. Table 2 below gives an exemplary characterization of XR services by data rate (or throughput) requirements and dominant transmission direction.

TABLE 2

| Dominant trans- | High data rate | Low data rate |
|---|---|---|
| mission direction | (large resource need) | (small resource need) |
| DL | VR | Cloud gaming, low-end VR |
| UL | High-end AR | Low-end AR |

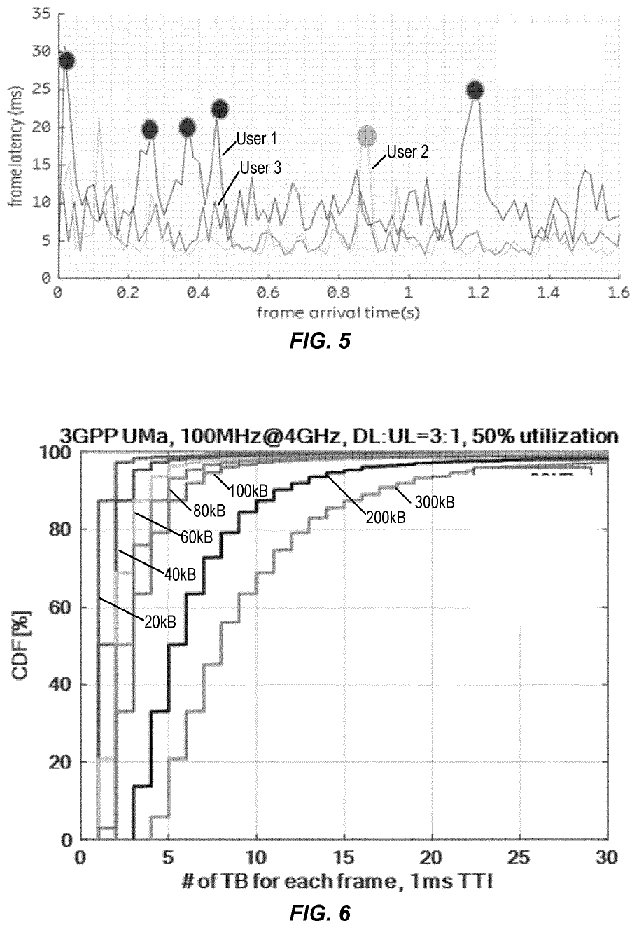

FIG. 5 shows an example of frame latency measured over a radio access network (RAN, e.g., NG-RAN), excluding latencies of application and core network (CN, e.g., 5GC). This measured RAN latency is highly variable across three different users (i.e., 1-3) and time (i.e., 0-1.6 s), with some spikes as high as 30 ms. The sources for the latency spikes may include queuing delay, time-varying radio environments, time-varying frame sizes, etc. Techniques that can mitigate, reduce, and/or eliminate such latency spikes are beneficial to NG-RAN support for XR traffic requiring bounded and/or predictable latency.

As briefly mentioned above, XR applications typically require high data rates. This is due to both high frame refresh rates and large video frame sizes that may range from tens to hundreds of kilobytes (kB). As a concrete example, a frame size of 100 kB and a frame refresh rate of 120 Hz can lead to a data rate requirement of 95.8 Mb/s.

Large video frames are usually fragmented into smaller Internet Protocol (IP) packets and transmitted as several transport blocks (TBs) over several TTIs in RAN. FIG. 6 shows exemplary cumulative distribution functions (CDFs) for the number of transport blocks (TBs) on the NR PHY required to deliver a video frame of size ranging from 20 to 300 kB. For example, FIG. 6 shows that for video frames of size 200 kB, the median number of TBs is 5 but in ˜5% of the cases, 15 or more TBs are required to deliver a 200-kB video frame. A 1-ms TTI and 100-MHz carrier bandwidth is assumed in FIG. 6.

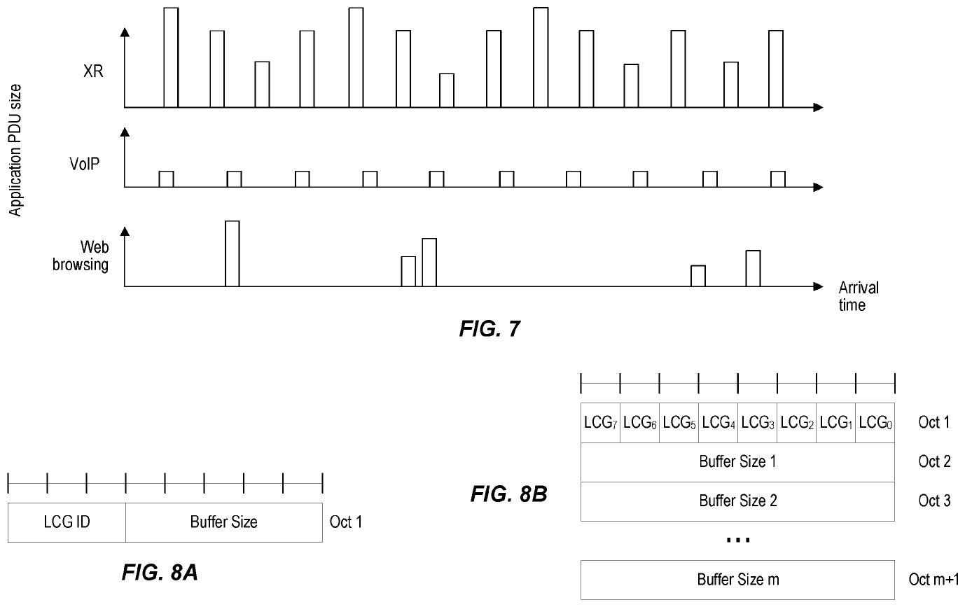

FIG. 7 shows a comparison of arrival times between XR, voice-over-IP (VOIP), and web browsing traffic. The characteristics of XR traffic arrival time is quasi-periodic and largely predictable. This is similar to VoIP but different than web browsing, in which arrival is very unpredictable. However, the size of XR traffic (e.g., video frames) is much larger than VoIP traffic, and can vary across arrivals due to dynamics of contents and human motion. As such, XR traffic shares some characteristics with web browsing traffic.

As briefly mentioned above, a UE reports the status of its buffers containing data waiting for UL transmission to the RAN. The UE reports this information in a MAC-layer control element (CE) called a buffer status report (BSR). The following BSR formats are used by UEs depending on various factors:
Short BSR format (fixed size),
Short Truncated BSR format (fixed size),
Long Truncated BSR format (variable size), and
Long BSR format (variable size).
   After receiving a BSR, a RAN node can adjust scheduling of UE UL transmissions accordingly.

FIG. 8A shows the format used for short and short truncated BSRs. This format includes a single octet carrying three (3) bits indicating a logical channel group (LCG) ID for which data is buffered, and five (5) bits indicating a size of the data buffered for the LCG ID.

FIG. 8B shows the format used for long and long truncated BSRs. This format includes one octet (October 1) that includes a bitmap in which each bit maps to a particular LCG ID, and multiple octets (2 to m+1) indicating sizes of buffered data for various LCG IDs. A bit value of “1” indicates that buffered data for the corresponding LCG ID is reported in one of octets 2 to m+1, while a bit value of “0” indicates that buffered data for the corresponding LCG ID is not reported.

There are three (3) types of BSRs: regular, periodic, and padding. A regular BSR is triggered if UL data, for a logical channel which belongs to an LCG, becomes available to the MAC entity and one of the following is true:
this UL data belongs to a logical channel with higher priority than the priority of any logical channel containing available UL data which belong to any LCG; or
none of the logical channels which belong to an LCG contains any available UL data.

When more than one LCG has data available for transmission, the UE uses the long BSR format and reports all LCGs which have data. In contrast, a UE uses short BSR format when only one LCG has data available for transmission.

Periodic BSR is configured by the RAN (e.g., serving gNB), including a reporting period. Similar to regular BSR, when more than one LCG has data available for transmission, the UE uses the long BSR format and reports all LCGs which have data. In contrast, a UE uses short BSR format when only one LCG has data available for transmission.

Padding BSR is an opportunistic method for the UE to provide buffer status information to the RAN when a MAC-layer PDU contains a number of padding (i.e., non-data) bits equal or larger than one of the BSR formats. In this case, the UE replaces the padding bits with a padding BSR having a format that corresponds (i.e., is no larger than) the number of padding bits. Note that one MAC PDU can contain no more than one BSR MAC CE.

Additionally, the padding BSR format depends on the number of logical channels that have data available for transmissions. When more than one LCG has data for transmission, the padding BSR uses a short truncated, long, or long truncated BSR format, depending on the number of available padding bits. When only one LCG has data for transmission, the padding BSR uses the short BSR format.

During Rel-18 work, 3GPP identified that the current UE BSR mechanism is inadequate for XR services. In general, a timely-received BSR can help to reduce latency of granting resources for UE transmission of the buffered data, as well as helping the RAN to determine the appropriate grant size. Inaccurate or non-timely BSRs for buffered XR data may lead to violation of the bounded latency requirements and/or incorrect grant size for relatively large XR PDU sets (e.g., for video). This can also impact network capacity and throughput performance.

For example, to address the bounded latency and bit rate requirements of XR traffic, the RAN needs to receive more precise buffer status information and timing information from UEs. 3GPP has identified some new BS tables and BSR formats that can help address these needs. Such new BSR formats may include information related to PDU Set/ADU as well as timing information for the PDU sets (which also may be referred to as “packets”).

Although new XR-related BSR reports may be able to provide such information, it is unclear how these new BSR reports can be triggered at the UE so they reach the RAN at the appropriate time (i.e., when needed by the RAN). Current BSR triggers are neither suitable nor sufficient to fulfill BSR requirements for XR services. Given the importance of XR services, improvements are needed to address these problems, issues, and/or difficulties.

Accordingly, embodiments of the present disclosure provide flexible and efficient triggering mechanisms for BSRs related to XR services (“XR-related BSR”). Various embodiments include triggering mechanisms based on delay, PDU set size, PDU discard, and/or outdated PDU sets.

Embodiments can provide various benefits and/or advantages. For example, embodiments trigger timely UE BSRs to the RAN, which enables the RAN to provide timely UL resource grants that support transmission of buffered XR data in a manner that meets bounded latency requirements. Moreover, embodiments facilitate RAN configuration of such BSR triggers, thereby giving the RAN control over UE BSRs. At a high level, embodiments facilitate delivery of XR services via wireless networks (e.g., RANs).

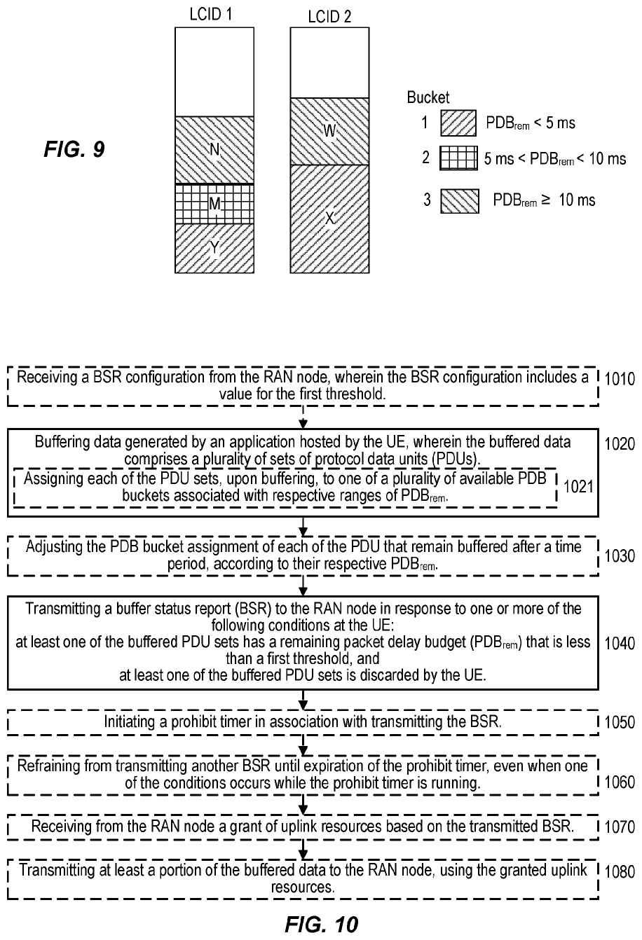

In some embodiments, UE BSR triggers can be based on delay or latency of PDU sets. The UE can classify PDU sets based on remaining PDU set delay budget, PDBᵣₑₘ, which is the actual PDU set delay budget (PDB) minus PDU set queued time, or based on PDU set queued time. In either case, the UE will classify the buffered PDU sets into different buckets or categories. FIG. 9 shows an exemplary arrangement in which UE-buffered PDU sets are classified based on remaining packet delay budget, PDBᵣₑₘ, according to various embodiments of the present disclosure

In the example shown in FIG. 9, the UE has two logical channels, which are identified by respective LCIDs and associated with different buffered PDU sets. In particular, LCID 1 is associated with PDU sets N, M, and Y, while LCID 2 is associated with PDU sets W and X. Each buffered PDU set (or packet) is assigned one of three labels or categories-referred to as “buckets”—based on how its PDBᵣₑₘ aligns with three configured ranges of PDBᵣₑₘ. In particular, packets X and Y are assigned to a first bucket based on having PDBᵣₑₘ less than 5 ms, packet M is assigned to a second bucket based on having PDBᵣₑₘ between 5 ms and 10 ms, and packets N and W are assigned to a third bucket based on having PDBᵣₑₘ greater than 10 ms.

In some embodiments, the RAN may configure the PDBᵣₑₘ thresholds or boundaries between buckets to be applied by the UE when categorizing PDU sets. Upon arrival of a PDU set in an LCID configured for XR traffic and/or with XR-related BSR, if the UE assigns the PDU set to a particular bucket based on the PDU set's PDBᵣₑₘ, the UE triggers a BSR and/or XR-related BSR that includes buffer status for the LCID (or for the LCG that includes the LCID, as discussed above). For example, a BSR can be triggered if an incoming PDU set is assigned to bucket 1 (but not buckets 2-3) in FIG. 9. As another example, a BSR can be triggered if an incoming PDU set is assigned to bucket 1 or to bucket 2 (but not bucket 3) in FIG. 9.

In other embodiments, the UE BSR triggers can be based on a change in bucket assignment for a PDU set. In the example shown in FIG. 9, after PDU set M has been queued for some duration, its assignment will change from bucket 2 to bucket 1 based on decreasing PDBᵣₑₘ. This change triggers a BSR by the UE to report on LCID 1.

In some embodiments, to avoid triggering too many BSRs, the UE can initiate a prohibitTimer upon triggering a BSR due to bucket assignment (or change in assignment) for a PDU set, and the UE cannot trigger another BSR due to bucket assignment (or change in assignment) for any PDU sets until after prohibitTimer has expired. The value used to initiate prohibitTimer can be pre-configured (e.g., in a 3GPP specification) or be configured by the RAN.

In other embodiments, to avoid triggering too many BSRs, the UE can trigger a BSR only after N>1 PDU set bucket assignments (or changes in assignment) that would otherwise trigger a BSR. The value N can be pre-configured (e.g., in a 3GPP specification) or be configured by the RAN.

In other embodiments, UE BSR triggers can be based on a combination of delay and size of PDU sets. In other words, the PDU set must meet delay/latency condition(s) and size condition(s) to trigger a BSR. Delay/latency conditions of these BSR triggers can be any of the conditions discussed above, e.g., bucket assignment or change in bucket assignment of PDU set.

In some embodiments, the size condition is that the PDU set must be above (or below) a PDU set size threshold. In other embodiments, the size condition is that a number, portion, or total size of all PDU sets assigned to a particular bucket (e.g., bucket 1 in FIG. 9) is above or below a total size threshold. Either of these thresholds can be pre-configured (e.g., in a 3GPP specification) or be configured by the RAN.

In some embodiments, in a similar manner as described above, the UE can initiate a prohibitTimer upon triggering a BSR due to PDU set(s) meeting a delay/latency condition and a size condition. The UE cannot trigger another BSR due to PDU set(s) meeting the same conditions until after prohibitTimer has expired. The value used to initiate prohibitTimer can be pre-configured (e.g., in a 3GPP specification) or be configured by the RAN.

In other embodiments, in a similar manner as described above, the UE can trigger a BSR only after N>1 occurrences of PDU set(s) meeting a delay/latency condition and a size condition, that would otherwise trigger a BSR. The value N can be pre-configured (e.g., in a 3GPP specification) or be configured by the RAN.

In other embodiments, UE BSR triggers can be based on the UE discarding one or more PDU sets. In some variants, the UE would trigger a BSR and/or XR-related BSR whenever a PDU Set is discarded. In other variants, the UE would trigger a BSR and/or XR-related BSR upon discarding N>1 PDU Sets. In other variants, the UE would trigger a BSR and/or XR-related BSR upon discarding a PDU Set having a size that is greater than a PDU set size threshold. The value of N or the PDU set size threshold can be pre-configured (e.g., in a 3GPP specification) or be configured by the RAN.

In other embodiments, UE BSR triggers can be based on a quantity or total size (e.g., in kB) of PDU sets for which PDBᵣₑₘ has reached a minimum value (e.g., 0). In some variants, the UE may drop or discard the PDU sets meeting this condition. In other variants, the UE may mark the PDU sets meeting this condition as “outdated” and move them to another queue with a different priority.

In various ones of these embodiments, UE BSR triggers can be based on a size-related threshold and/or an overdue threshold. For example, a BSR can be triggered when the number of PDU sets or the total size of PDU sets meeting this condition is above the size-related threshold.

In general, the overdue threshold can be considered as the minimal value mentioned above. In some cases, the overdue threshold may be implicit, such as zero or some pre-configured value. In other cases, a non-zero overdue threshold may be configured. In any case, when queued time (or PDBᵣₑₘ) for one or more PDU sets reaches the overdue threshold, a BSR will be triggered. Alternately, the size-related threshold can be combined with the overdue threshold, such that the number of PDU sets or the total size of PDU sets meeting the overdue threshold also must meet the size-related threshold for a BSR to be triggered.

In other embodiments, UE BSR triggers can be based on a change in the number of size of buffered PDU sets. For example, a UE BSR is triggered when the total number or the total size (e.g., in kB) of buffered PDU sets increases (or decreases) more than a change threshold. When the change threshold is based on a total number of buffered PDU sets, increasing the size of one PDU set does not trigger BSR. Although these embodiments do not require a delay/latency condition, they can be combined with such a condition in a similar manner as other embodiments described above.

In other embodiments, UE BSR triggers can be based on an explicit indication from the serving RAN node, which can be provided in physical layer downlink control information (DCI). In some variants, the explicit indication can indicate a type or format of BSR to send, a particular BS table to be used to generate the BSR, etc. In other variants, the explicit indication can merely indicate that a BSR is required, with the type of BSR being determined by the UE based on pre-configuration (e.g., specification) or previous configuration by the RAN. Upon receiving the explicit indication, the UE will create a BSR accordingly, including any empty BSR if no buffered data is available to report.

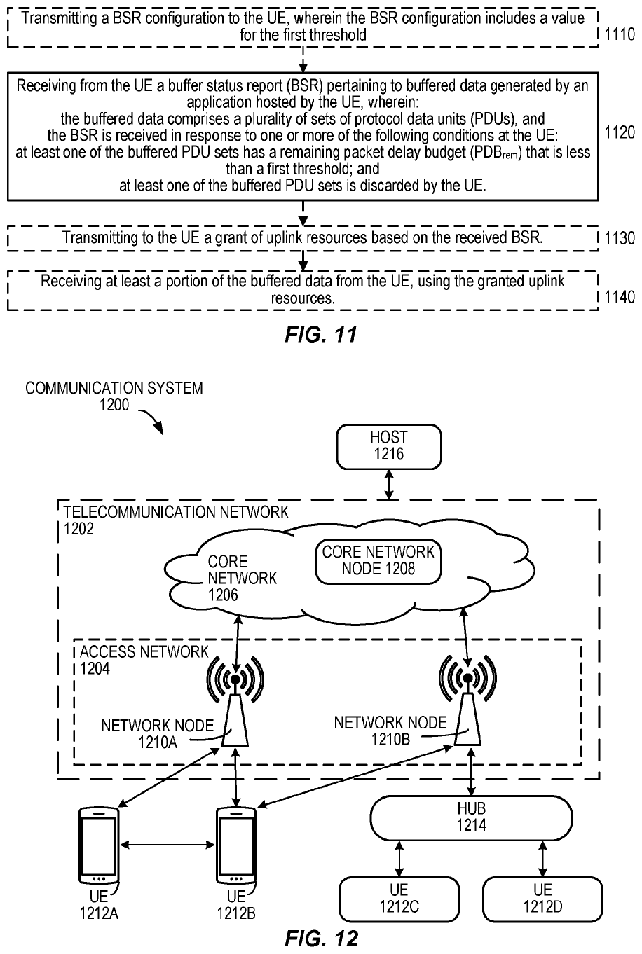

Various features of the embodiments described above correspond to various operations illustrated in FIGS. 10-11, which show exemplary methods (e.g., procedures) for a UE and a RAN node, respectively. In other words, various features of the operations described below correspond to various embodiments described above. Furthermore, the exemplary methods shown in FIGS. 10-11 can be used cooperatively to provide various benefits, advantages, and/or solutions to problems described herein. Although FIGS. 10-11 show specific blocks in particular orders, the operations of the exemplary methods can be performed in different orders than shown and can be combined and/or divided into blocks having different functionality than shown. Optional blocks or operations are indicated by dashed lines.

Skilled persons reading the description of FIGS. 10-11 and the corresponding claims will recognize that numerical labels “first” through “seventh” are not used in an ordinal sense to imply any type of order, ranking, etc. of the so-labelled “thresholds”. Rather, skilled persons will recognize that these numerical labels are used in a nominal sense to distinguish between different ones of the so-labelled “thresholds” in the description and the corresponding claims.

In particular, FIG. 10 shows an exemplary method (e.g., procedure) for a UE configured to transmit application data to a RAN node, according to various embodiments of the present disclosure. The exemplary method can be performed by a UE (e.g., wireless device, IoT device, etc.) such as described elsewhere herein.

The exemplary method includes the operations of block 1020, where the UE buffers data generated by an application hosted by the UE. The buffered data comprises a plurality of sets of protocol data units (PDUs). The exemplary method also includes the operations of block 1040, where the UE transmits a buffer status report (BSR) to the RAN node in response to one or more of the following conditions at the UE:
at least one of the buffered PDU sets has a remaining packet delay budget (PDBᵣₑₘ) that is less than a first threshold, wherein PDBᵣₑₘ for a PDU set decreases in proportion to a duration that the PDU set has been buffered; and
at least one of the buffered PDU sets discarded by the UE.

In some embodiments, the transmitted BSR indicates an amount of data corresponding to buffered PDU sets that meet the one or more conditions at the UE. In some embodiments, the exemplary method can also include the operations of block 1010, where the UE can receive a BSR configuration from the RAN node. The BSR configuration includes a value for the first threshold. In some embodiments, buffering data in block 1020 can include the operations of sub-block 1021, where the UE assigns each of the PDU sets, upon buffering, to one of a plurality of available PDB buckets associated with respective ranges of PDBᵣₑₘ. FIG. 9 shows an example of these embodiments. In some of these embodiments, the first threshold corresponds to one or more PDB buckets that are associated with one or more lowest ranges of PDBᵣₑₘ.

In some embodiments, the BSR is also transmitted to the RAN node in response to any of the following conditions at the UE:
a number or total size of buffered PDU sets with PDBᵣₑₘ greater than a second threshold is at least a third threshold;
a number or total size of buffered PDU sets with PDBᵣₑₘ that change from greater than to less than a fourth threshold, is at least a fifth threshold;
a number or total size of buffered PDU sets that are overdue is at least an sixth threshold;
a number or total size of buffered PDU sets changes by at least a seventh threshold; and
an explicit indication received from the RAN node.

In some of these embodiments, the exemplary method also includes the operations of block 1030, where the UE adjusts the PDB bucket assignment of each of the PDUs that remains buffered after a time period, according to their respective PDBᵣₑₘ. For example, the PDB bucket assignments can be adjusted periodically or in response to certain events, such as buffering of a newly available PDU set. The fourth threshold corresponds to a boundary between two PDB buckets associated with adjacent ranges of PDBᵣₑₘ.

In some of these embodiments, when the explicit indication is received from the RAN node, the BSR is transmitted to the RAN node in block 1040 even if no data generated by the application is currently buffered. In some of these embodiments, each of the third, fifth, sixth, and seventh thresholds is one of the following: a single PDU set, a plurality (N) of PDU sets, or a number of kilobytes.

In some embodiments, the exemplary method can also include the operations of blocks 1050-1060, where the UE can initiate a prohibit timer in association with transmitting the BSR and refrain from transmitting another BSR until expiration of the prohibit timer, even when one of the conditions occurs while the prohibit timer is running.

In some embodiments, the exemplary method can also include the operations of blocks 1070-1080, where the UE can receive from the RAN node a grant of uplink resources based on the transmitted BSR and transmit at least a portion of the buffered data to the RAN node, using the granted uplink resources.

In some embodiments, the application is an extended reality (XR) application and the data generated by the application has a bounded latency requirement.

In addition, FIG. 11 shows an exemplary method (e.g., procedure) for a RAN node configured to receive application data from a UE, according to various embodiments of the present disclosure. The exemplary method can be performed by a RAN node (e.g., base station, eNB, gNB, ng-eNB, etc., or component thereof) such as described elsewhere herein.

The exemplary method includes the operations of block 1110, where the RAN node receives from the UE a BSR pertaining to buffered data generated by an application hosted by the UE. The buffered data comprises a plurality of sets of PDUs. Moreover, the BSR is received in response to one or more of the following conditions at the UE:
at least one of the buffered PDU sets has a remaining packet delay budget (PDBᵣₑₘ) that is less than a first threshold, wherein PDBᵣₑₘ for a PDU set decreases in proportion to a duration that the PDU set has been buffered; and
at least one of the buffered PDU sets is discarded by the UE.

In some embodiments, the received BSR indicates an amount of data corresponding to buffered PDU sets that meet the one or more conditions at the UE. In some embodiments, the exemplary method can also include the operations of block 1110, where the RAN node can transmit a BSR configuration to the UE. The BSR configuration includes a value for the first threshold.

In some embodiments, each of the PDU sets is assigned by the UE, upon buffering, to one of a plurality of available PDB buckets associated with respective ranges of PDBᵣₑₘ. FIG. 9 shows an example of these embodiments. In some of these embodiments, the first threshold corresponds to one or more PDB buckets that are associated with one or more lowest ranges of PDBᵣₑₘ.

In some of these embodiments, the BSR is also received from the UE in response any of the following conditions at the UE:
a number or total size of buffered PDU sets with PDBᵣₑₘ greater than a second threshold is at least a third threshold;
a number or total size of buffered PDU sets with PDBᵣₑₘ that change from greater than to less than a fourth threshold, is at least a fifth threshold;
a number or total size of buffered PDU sets that are overdue is at least an sixth threshold;
a number or total size of buffered PDU sets changes by at least a seventh threshold; and
an explicit indication received from the RAN node.

In some of these embodiments, the PDB bucket assignments of the PDU sets that remain buffered after a time period are adjusted by the UE according to their respective PDBᵣₑₘ. For example, the PDB bucket assignments can be adjusted periodically or in response to certain events, such as buffering of a newly available PDU set. The fourth corresponds to a boundary between two PDB buckets associated with adjacent ranges of PDBᵣₑₘ.

In some of these embodiments, when the explicit indication is sent to the UE, the BSR is received from the UE in block 1120 even when no data generated by the application is currently buffered at the UE. In some of these embodiments, each of the third, fifth, sixth, and seventh thresholds is one of the following: a single PDU set, a plurality (N) of PDU sets, or a number of kilobytes.

In some embodiments, the exemplary method also includes the operations of blocks 1130-1140, where RAN node transmits to the UE a grant of uplink resources based on the received BSR and receives at least a portion of the buffered data from the UE, using the granted uplink resources.

In some embodiments, the application is an XR application and the data generated by the application has a bounded latency requirement.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

FIG. 12 shows an example of a communication system 1200 in accordance with some embodiments. In this example, communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a-b (one or more of which may be generally referred to as network nodes 1210), or any other similar 3GPP access node or non-3GPP access point. Network nodes 1210 facilitate direct or indirect connection of UEs, such as by connecting UEs 1212a-d (one or more of which may be generally referred to as UEs 1212) to core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1200 may include any number of wired or wireless networks, network nodes, UEs, and/or any other components or systems that may facilitate or participate in the communication of data and/or signals whether via wired or wireless connections. Communication system 1200 may include and/or interface with any type of communication, telecommunication, data, cellular, radio network, and/or other similar type of system.

UEs 1212 may be any of a wide variety of communication devices, including wireless devices arranged, configured, and/or operable to communicate wirelessly with network nodes 1210 and other communication devices. Similarly, network nodes 1210 are arranged, capable, configured, and/or operable to communicate directly or indirectly with UEs 1212 and/or with other network nodes or equipment in telecommunication network 1202 to enable and/or provide network access, such as wireless network access, and/or to perform other functions, such as administration in telecommunication network 1202.

In the depicted example, core network 1206 connects network nodes 1210 to one or more hosts, such as host 1216. These connections may be direct or indirect via one or more intermediary networks or devices. In other examples, network nodes may be directly coupled to hosts. Core network 1206 includes one or more core network nodes (e.g., 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1216 may be under the ownership or control of a service provider other than an operator or provider of access network 1204 and/or telecommunication network 1202, and may be operated by the service provider or on behalf of the service provider. Host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1202 is a cellular network that implements 3GPP standardized features. Accordingly, telecommunications network 1202 may support network slicing to provide different logical networks to different devices that are connected to telecommunication network 1202. For example, telecommunication network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1212 are configured to transmit and/or receive information without direct human interaction. For instance, a UE may be designed to transmit information to access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 1214 communicates with the access network 1204 to facilitate indirect communication between one or more UEs (e.g., UE 1212c and/or 1212d) and network nodes (e.g., network node 1210b). In some examples, hub 1214 may be a controller, router, content source and analytics, or any of the other communication devices described herein regarding UEs. For example, hub 1214 may be a broadband router enabling access to the core network 1206 for the UEs. As another example, hub 1214 may be a controller that sends commands or instructions to one or more actuators in the UEs. Commands or instructions may be received from the UEs, network nodes 1210, or by executable code, script, process, or other instructions in hub 1214. As another example, hub 1214 may be a data collector that acts as temporary storage for UE data and, in some embodiments, may perform analysis or other processing of the data. As another example, hub 1214 may be a content source. For example, for a UE that is a VR headset, display, loudspeaker or other media delivery device, hub 1214 may retrieve VR assets, video, audio, or other media or data related to sensory information via a network node, which the hub 1214 then provides to the UE either directly, after performing local processing, and/or after adding additional local content. In still another example, hub 1214 acts as a proxy server or orchestrator for the UEs, in particular in if one or more of the UEs are low energy IoT devices.

Hub 1214 may have a constant/persistent or intermittent connection to the network node 1210b. Hub 1214 may also allow for a different communication scheme and/or schedule between hub 1214 and UEs (e.g., UE 1212c and/or 1212d), and between hub 1214 and core network 1206. In other examples, hub 1214 is connected to core network 1206 and/or one or more UEs via a wired connection. Moreover, hub 1214 may be configured to connect to an M2M service provider over access network 1204 and/or to another UE over a direct connection. In some scenarios, UEs may establish a wireless connection with network nodes 1210 while still connected via hub 1214 via a wired or wireless connection. In some embodiments, hub 1214 may be a dedicated hub—that is, a hub whose primary function is to route communications to/from the UEs from/to network node 1210b. In other embodiments, hub 1214 may be a non-dedicated hub—that is, a device which is capable of operating to route communications between the UEs and network node 1210b, but which is additionally capable of operating as a communication start and/or end point for certain data channels.

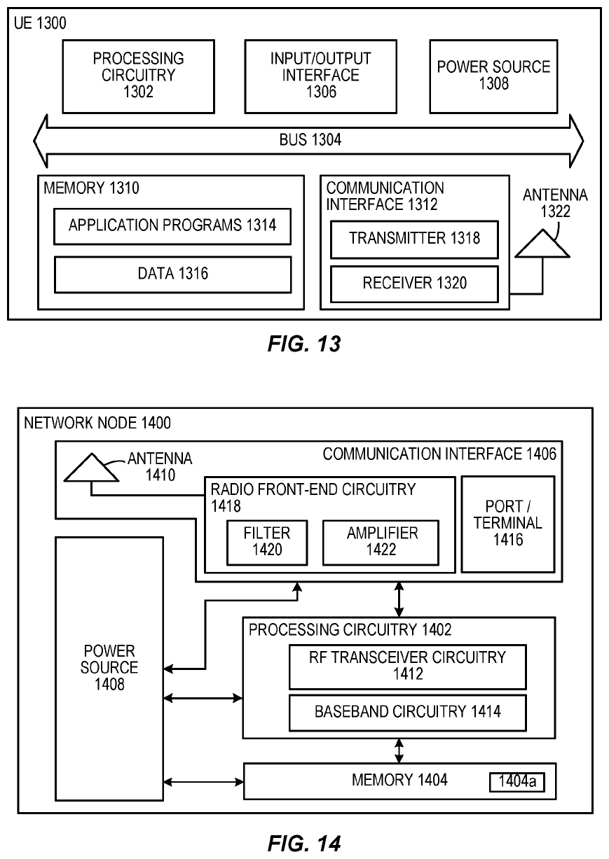

FIG. 13 shows a UE 1300 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1300 includes processing circuitry 1302 that is operatively coupled via bus 1304 to input/output interface 1306, power source 1308, memory 1310, communication interface 1312, and possibly one or more other components not explicitly shown. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

Processing circuitry 1302 is configured to process instructions and data and may be configured to implement any sequential state machine operative to execute instructions stored as machine-readable computer programs in memory 1310. Processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1308 is structured as a battery or battery pack. Other types of power sources, such as an external power source (e.g., an electricity outlet), photovoltaic device, or power cell, may be used. Power source 1308 may further include power circuitry for delivering power from power source 1308 itself, and/or an external power source, to the various parts of UE 1300 via input circuitry or an interface such as an electrical power cable. Delivering power may be, for example, for charging power source 1308. Power circuitry may perform any formatting, converting, or other modification to the power from power source 1308 to make the power suitable for the respective components of UE 1300 to which power is supplied.

Memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1310 includes one or more application programs 1314, such as an operating system, web browser application, a widget, gadget engine, or other application, and corresponding data 1316. Memory 1310 may store, for use by the UE 1300, any of a variety of various operating systems or combinations of operating systems.

Memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as “SIM card.” Memory 1310 may allow UE 1300 to access instructions, application programs and the like, stored on transitory or non-transitory memory media, to off-load data, or to upload data. An article of manufacture, such as one utilizing a communication system may be tangibly embodied as or in memory 1310, which may be or comprise a device-readable storage medium.

Processing circuitry 1302 may be configured to communicate with an access network or other network using communication interface 1312. Communication interface 1312 may comprise one or more communication subsystems and may include or be communicatively coupled to an antenna 1322. Communication interface 1312 may include one or more transceivers used to communicate, such as by communicating with one or more remote transceivers of another device capable of wireless communication (e.g., another UE or a network node in an access network). Each transceiver may include transmitter 1318 and/or receiver 1320 appropriate to provide network communications (e.g., optical, electrical, frequency allocations, and so forth). Moreover, transmitter 1318 and/or receiver 1320 may be coupled to one or more antennas (e.g., 1322) and may share circuit components, software, or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 1400 in accordance with some embodiments. Examples of network nodes include, but are not limited to, access points (e.g., radio access points) and base stations (e.g., radio base stations, Node Bs, eNBs, gNBs, etc.).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1400 includes processing circuitry 1402, memory 1404, communication interface 1406, and power source 1408. Network node 1400 may be composed of multiple physically separate components (e.g., a NodeB component and a RNC component, or a BTS component and a BSC component, etc.), which may each have their own respective components. In certain scenarios in which network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). Network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

Processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, processing circuitry 1402 includes a system on a chip (SOC). In some embodiments, processing circuitry 1402 includes one or more of radio frequency (RF) transceiver circuitry 1412 and baseband processing circuitry 1414. In some embodiments, RF transceiver circuitry 1412 and baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

Memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1402. Memory 1404 may store any suitable instructions, data, or information, including a computer program, software, an application including one or more of logic, rules, code, tables, and/or other instructions (collectively denoted computer program product 1404a) capable of being executed by processing circuitry 1402 and utilized by network node 1400. Memory 1404 may be used to store any calculations made by processing circuitry 1402 and/or any data received via the communication interface 1406. In some embodiments, processing circuitry 1402 and memory 1404 can be integrated.

Communication interface 1406 is used in wired or wireless communication of signaling and/or data between a network node, access network, and/or UE. As illustrated, communication interface 1406 comprises port(s)/terminal(s) 1416 to send and receive data, for example to and from a network over a wired connection. Communication interface 1406 also includes radio front-end circuitry 1418 that may be coupled to, or in certain embodiments a part of, antenna 1410. Radio front-end circuitry 1418 comprises filters 1420 and amplifiers 1422. Radio front-end circuitry 1418 may be connected to antenna 1410 and processing circuitry 1402. The radio front-end circuitry may be configured to condition signals communicated between antenna 1410 and processing circuitry 1402. Radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of filters 1420 and/or amplifiers 1422. The radio signal may then be transmitted via antenna 1410. Similarly, when receiving data, antenna 1410 may collect radio signals which are then converted into digital data by radio front-end circuitry 1418. The digital data may be passed to processing circuitry 1402. In other embodiments, the communication interface may comprise different components and/or different combinations of components.

In certain alternative embodiments, network node 1400 does not include separate radio front-end circuitry 1418, instead, processing circuitry 1402 includes radio front-end circuitry and is connected to antenna 1410. Similarly, in some embodiments, some or all of RF transceiver circuitry 1412 may be part of communication interface 1406. In still other embodiments, communication interface 1406 includes one or more ports or terminals 1416, radio front-end circuitry 1418, and RF transceiver circuitry 1412, as part of a radio unit (not shown), and communication interface 1406 communicates with baseband processing circuitry 1414, which is part of a digital unit (not shown).

Antenna 1410 may include one or more antennas, or antenna arrays, configured to send and/or receive wireless signals. Antenna 1410 may be coupled to radio front-end circuitry 1418 and may be any type of antenna capable of transmitting and receiving data and/or signals wirelessly. In certain embodiments, antenna 1410 is separate from network node 1400 and connectable to network node 1400 through an interface or port.

Antenna 1410, communication interface 1406, and/or processing circuitry 1402 may be configured to perform any receiving operations and/or certain obtaining operations described herein as being performed by the network node. Any information, data and/or signals may be received from a UE, another network node and/or any other network equipment. Similarly, antenna 1410, communication interface 1406, and/or processing circuitry 1402 may be configured to perform any transmitting operations described herein as being performed by the network node. Any information, data and/or signals may be transmitted to a UE, another network node and/or any other network equipment.

Power source 1408 provides power to various components of network node 1400 in a form suitable for the respective components (e.g., at a voltage and current level needed for each respective component). Power source 1408 may further comprise, or be coupled to, power management circuitry to supply the components of network node 1400 with power for performing the functionality described herein. For example, network node 1400 may be connectable to an external power source (e.g., the power grid, an electricity outlet) via an input circuitry or interface such as an electrical cable, whereby the external power source supplies power to power circuitry of power source 1408. As a further example, power source 1408 may comprise a source of power in the form of a battery or battery pack which is connected to, or integrated in, power circuitry. The battery may provide backup power should the external power source fail.

Embodiments of network node 1400 may include additional components beyond those shown in FIG. 14 for providing certain aspects of the network node's functionality, including any of the functionality described herein and/or any functionality necessary to support the subject matter described herein. For example, network node 1400 may include user interface equipment to allow input of information into network node 1400 and to allow output of information from network node 1400. This may allow a user to perform diagnostic, maintenance, repair, and other administrative functions for network node 1400.

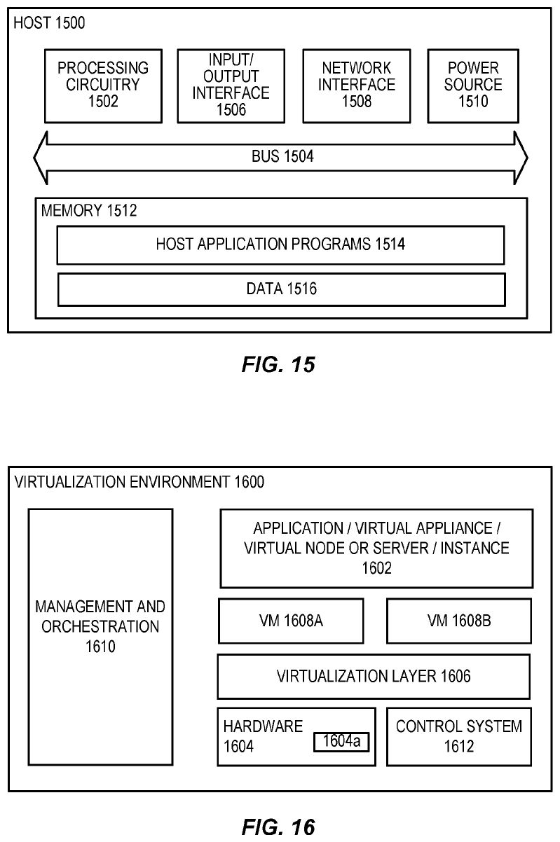

FIG. 15 is a block diagram of a host 1500, which may be an embodiment of host 1216 of FIG. 12, in accordance with various aspects described herein. Host 1500 may be or comprise various combinations hardware and/or software, including a standalone server, a blade server, a cloud-implemented server, a distributed server, a virtual machine, container, or processing resources in a server farm. Host 1500 may provide one or more services to one or more UEs.

Host 1500 includes processing circuitry 1502 that is operatively coupled via bus 1504 to input/output interface 1506, network interface 1508, power source 1510, and a 1512. Other components may be included in other embodiments. Features of these components may be substantially similar to those described with respect to the devices of previous figures, such as FIGS. 13 and 14, such that the descriptions thereof are generally applicable to the corresponding components of host 1500.

Memory 1512 may include one or more computer programs including one or more host application programs 1514 and data 1516, which may include user data, e.g., data generated by a UE for host 1500 or data generated by host 1500 for a UE. Embodiments of host 1500 may utilize only a subset or all of the components shown. Host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1514 may also provide for user authentication and licensing checks and may periodically report health, routes, and content availability to a central node, such as a device in or on the edge of a core network. Accordingly, host 1500 may select and/or indicate a different host for over-the-top services for a UE. Host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment 1600 to implement some of the features, functions, and/or benefits of some of the embodiments disclosed herein.

Hardware 1604 includes processing circuitry, memory that stores software and/or instructions (collective denoted computer program product 1604a) executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a-b (one or more of which may be generally referred to as VMs 1608), and/or perform any of the functions, features and/or benefits described in relation with some embodiments described herein. Virtualization layer 1606 may present a virtual operating platform that appears like networking hardware to VMs 1608.

VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1608 may be a software implementation of a physical machine that runs programs as if they were executing on a physical, non-virtualized machine. Each VM 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of hardware 1604 and corresponds to application 1602.

Hardware 1604 may be implemented in a standalone network node with generic or specific components. Hardware 1604 may implement some functions via virtualization. Alternatively, hardware 1604 may be part of a larger cluster of hardware (e.g., such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

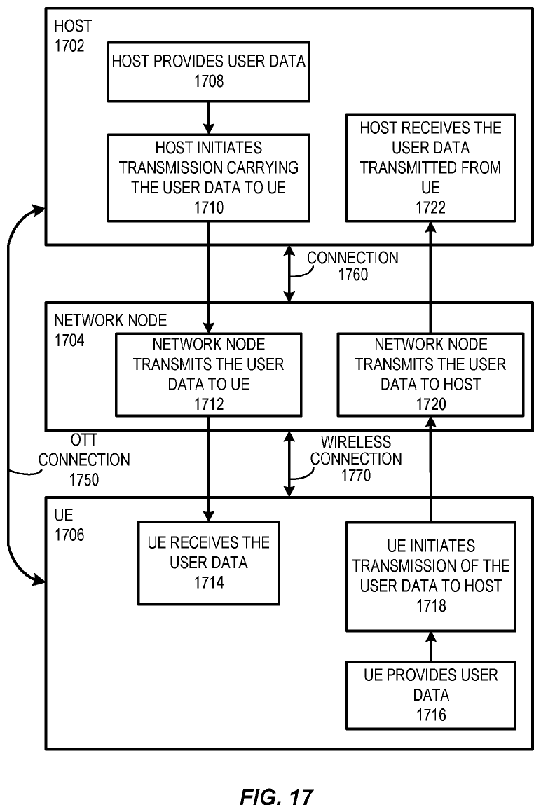

FIG. 17 shows a communication diagram of host 1702 communicating via network node 1704 with UE 1706 over a partially wireless connection in accordance with some embodiments. Example implementations, in accordance with various embodiments, of the UE (such as UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. Host 1702 also includes software, which is stored in or accessible by host 1702 and executable by the processing circuitry. The software includes a host application that may be operable to provide a service to a remote user, such as UE 1706 connecting via an over-the-top (OTT) connection 1750 extending between UE 1706 and host 1702. In providing the service to the remote user, a host application may provide user data which is transmitted using OTT connection 1750.

Network node 1704 includes hardware enabling it to communicate with host 1702 and UE 1706. Connection 1760 may be direct or pass through a core network (like core network 1206 of FIG. 12) and/or one or more other intermediate networks, such as one or more public, private, or hosted networks. For example, an intermediate network may be a backbone network or the Internet.

UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of host 1702. In host 1702, an executing host application may communicate with the executing client application via OTT connection 1750 terminating at UE 1706 and host 1702. In providing the service to the user, the UE's client application may receive request data from the host's host application and provide user data in response to the request data. OTT connection 1750 may transfer both the request data and the user data. The UE's client application may interact with the user to generate the user data that it provides to the host application through OTT connection 1750.

OTT connection 1750 may extend via a connection 1760 between host 1702 and network node 1704 and via a wireless connection 1770 between network node 1704 and UE 1706 to provide the connection between host 1702 and UE 1706. Connection 1760 and wireless connection 1770, over which OTT connection 1750 may be provided, have been drawn abstractly to illustrate the communication between host 1702 and UE 1706 via network node 1704, without explicit reference to any intermediary devices and the precise routing of messages via these devices.

As an example of transmitting data via OTT connection 1750, in step 1708, host 1702 provides user data, which may be performed by executing a host application. In some embodiments, the user data is associated with a particular human user interacting with UE 1706. In other embodiments, the user data is associated with UE 1706 that shares data with host 1702 without explicit human interaction. In step 1710, host 1702 initiates a transmission carrying the user data towards UE 1706. Host 1702 may initiate the transmission responsive to a request transmitted by the UE 1706. The request may be caused by human interaction with UE 1706 or by operation of the client application executing on UE 1706. The transmission may pass via network node 1704, in accordance with the teachings of the embodiments described throughout this disclosure. Accordingly, in step 1712, network node 1704 transmits to UE 1706 the user data that was carried in the transmission that host 1702 initiated, in accordance with the teachings of the embodiments described throughout this disclosure. In step 1714, UE 1706 receives the user data carried in the transmission, which may be performed by a client application executed on UE 1706 associated with the host application executed by host 1702.

In some examples, UE 1706 executes a client application which provides user data to host 1702. The user data may be provided in reaction or response to the data received from host 1702. Accordingly, in step 1716, UE 1706 may provide user data, which may be performed by executing the client application. In providing the user data, the client application may further consider user input received from the user via an input/output interface of UE 1706. Regardless of the specific manner in which the user data was provided, UE 1706 initiates, in step 1718, transmission of the user data towards host 1702 via network node 1704. In step 1720, in accordance with the teachings of the embodiments described throughout this disclosure, network node 1704 receives user data from UE 1706 and initiates transmission of the received user data towards host 1702. In step 1722, host 1702 receives the user data carried in the transmission initiated by UE 1706.

One or more of the various embodiments improve the performance of OTT services provided to UE 1706 using OTT connection 1750, in which wireless connection 1770 forms the last segment. More precisely, embodiments described herein can trigger timely UE BSRs to the RAN, which enables the RAN to provide timely UL resource grants that support transmission of buffered XR data in a manner that meets bounded latency requirements. Moreover, embodiments facilitate RAN configuration of such BSR triggers, thereby giving the RAN control over UE BSRs. At a high level, embodiments facilitate and/or improve delivery of OTT XR services via wireless networks (e.g., RANs). In this manner, embodiments increase the value of these OTT XR services to end users and service providers.

In an example scenario, factory status information may be collected and analyzed by host 1702. As another example, host 1702 may process audio and video data which may have been retrieved from a UE for use in creating maps. As another example, host 1702 may collect and analyze real-time data to assist in controlling vehicle congestion (e.g., controlling traffic lights). As another example, host 1702 may store surveillance video uploaded by a UE. As another example, host 1702 may store or control access to media content such as video, audio, VR or AR which it can broadcast, multicast or unicast to UEs. As other examples, host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency, and other factors on which the one or more embodiments improve. There may further be an optional network functionality for reconfiguring OTT connection 1750 between the 1702 and UE 1706, in response to variations in the measurement results. The measurement procedure and/or the network functionality for reconfiguring OTT connection may be implemented in software and hardware of host 1702 and/or UE 1706. In some embodiments, sensors (not shown) may be deployed in or in association with other devices through which OTT connection 1750 passes; the sensors may participate in the measurement procedure by supplying values of the monitored quantities exemplified above, or supplying values of other physical quantities from which software may compute or estimate the monitored quantities. The reconfiguring of OTT connection 1750 may include message format, retransmission settings, preferred routing etc.; the reconfiguring need not directly alter operation of network node 1704. Such procedures and functionalities may be known and practiced in the art. In certain embodiments, measurements may involve proprietary UE signaling that facilitates measurements of throughput, propagation times, latency, and the like, by host 1702. The measurements may be implemented in that software causes messages to be transmitted, in particular empty or ‘dummy’ messages, using OTT connection 1750 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:
A1. A method for a user equipment (UE) configured to transmit application data to a radio access network (RAN) node, the method comprising:
   buffering data generated by an application hosted by the UE, wherein:
      the buffered data comprises a plurality of sets of protocol data units (PDUs), and
      each buffered PDU set is associated with a remaining packet delay budget (PDBᵣₑₘ) that decreases in proportion to a duration of buffering; and
   transmitting a buffer status report (BSR) to the RAN node in response to detecting one or more of the following conditions:
      a first condition wherein a number or total size of buffered PDU sets with PDBᵣₑₘ less than a first threshold is at least a second threshold;
      a second condition wherein a number or total size of buffered PDU sets with PDBᵣₑₘ greater than a third threshold is at least a fourth threshold;
      a third condition wherein a number or total size of buffered PDU sets with PDBᵣₑₘ that change from greater than to less than a fifth threshold, is at least a sixth threshold;
      a fourth condition wherein a number or total size of buffered PDU sets discarded by the UE is at least a seventh threshold;
      a fifth condition wherein a number or total size of buffered PDU sets that are overdue is at least an eighth threshold;
      a sixth condition wherein a number or total size of buffered PDU sets changes by at least a ninth threshold; and
      an explicit indication received from the RAN node.
A2. The method of embodiment A1, wherein the transmitted BSR indicates an amount of data corresponding to buffered PDU sets that meet the one or more conditions detected by the UE
A3. The method of any of embodiments A1-A2, further comprising receiving a BSR configuration from the RAN node, wherein the BSR configuration includes values for one or more of the first, second, third, fourth, fifth, sixth, and seventh thresholds used in detecting the one or more conditions.
A4. The method of any of embodiments A1-A3, wherein each of the second, fourth, sixth, seventh, eighth, and ninth thresholds is one of the following: a single PDU set, a plurality (N) of PDU sets, or a number of kilobytes.
A5. The method of any of embodiments A1-A4, wherein:
   buffering data comprises assigning each of the PDU sets, upon buffering, to one of a plurality of available PDB buckets associated with respective ranges of PDBᵣₑₘ, and
   the first threshold associated with the first condition corresponds to one or more PDB buckets that are associated with one or more lowest ranges of PDBᵣₑₘ.
A6. The method of embodiment A5,
   the method further comprises adjusting the PDB bucket assignment of each of the PDU that remain buffered after a time period, according to their respective PDBᵣₑₘ; and
   the fifth threshold associated with the third condition corresponds to a boundary between two PDB buckets associated with adjacent ranges of PDBᵣₑₘ.
A7. The method of any of embodiments A1-A6, further comprising:
   initiating a prohibit timer in association with transmitting the BSR; and
   refraining from transmitting another BSR until expiration of the prohibit timer, even if one of the conditions is detected while the prohibit timer is running.
A8. The method of any of embodiments A1-A7, wherein when the explicit indication is received from the RAN node, the BSR is transmitted to the RAN node even if no data generated by the application is currently buffered.
A9. The method of any of embodiments A1-A8, further comprising:
   receiving from the RAN node a grant of uplink resources based on the transmitted BSR; and
   transmitting at least a portion of the buffered data to the RAN node, using the granted uplink resources.
A10. The method of any of embodiments A1-A9, wherein the application is an extended reality (XR) application and the data generated by the application has a bounded latency requirement.
B1. A method for a radio access network (RAN) node configured to receive application data from a user equipment (UE), the method comprising:
   receiving from the UE a buffer status report (BSR) pertaining to buffered data generated by an application hosted by the UE, wherein:
      the buffered data comprises a plurality of sets of protocol data units (PDUs);
      each buffered PDU set is associated with a remaining packet delay budget (PDBᵣₑₘ) that decreases in proportion to a duration of buffering; and
      the BSR is received in response to UE detection of one or more of the following conditions:
         a first condition wherein a number or total size of buffered PDU sets with PDBᵣₑₘ less than a first threshold is at least a second threshold,
         a second condition wherein a number or total size of buffered PDU sets with PDBᵣₑₘ greater than a third threshold is at least a fourth threshold,
         a third condition wherein a number or total size of buffered PDU sets with PDBᵣₑₘ that change from greater than to less than a fifth threshold, is at least a sixth threshold,
         a fourth condition wherein a number or total size of buffered PDU sets discarded by the UE is at least a seventh threshold,
         a fifth condition wherein a number or total size of buffered PDU sets that are overdue is at least an eighth threshold,
         a sixth condition wherein a number or total size of buffered PDU sets changes by at least a ninth threshold, and
         an explicit indication sent by the RAN node.
B2. The method of embodiment B1, wherein the received BSR indicates an amount of data corresponding to buffered PDU sets that meet the one or more conditions detected by the UE.
B3. The method of any of embodiments B1-B2, further comprising transmitting a BSR configuration to the UE, wherein the BSR configuration includes values for one or more of the first, second, third, fourth, fifth, sixth, and seventh thresholds used in UE detection of the one or more conditions.
B4. The method of any of embodiments B1-B3, wherein each of the second, fourth, sixth, seventh, eighth, and ninth thresholds is one of the following: a single PDU set, a plurality (N) of PDU sets, or a number of kilobytes.
B5. The method of any of embodiments B1-B4, wherein:
   each of the PDU sets is assigned, upon buffering, to one of a plurality of available PDB buckets associated with respective ranges of PDBᵣₑₘ; and
   the first threshold associated with the first condition corresponds to one or more PDB buckets that are associated with one or more lowest ranges of PDBᵣₑₘ.
B6. The method of embodiment B5,
   the PDB bucket assignments of the PDU sets that remain buffered after a time period are adjusted according to their respective PDBᵣₑₘ; and
   the fifth threshold associated with the third condition corresponds to a boundary between two PDB buckets associated with adjacent ranges of PDBᵣₑₘ.
B7. The method of any of embodiments B1-B6, wherein after receiving the BSR, no further BSRs are received from the UE for at least a duration corresponding to a UE prohibit timer.
B8. The method of any of embodiments B1-B7, wherein when the explicit indication is sent to the UE, the BSR is received from the UE even if no data generated by the application is currently buffered at the UE.
B9. The method of any of embodiments B1-B8, further comprising:
   transmitting to the UE a grant of uplink resources based on the received BSR; and
   receiving at least a portion of the buffered data from the UE, using the granted uplink resources.
B10. The method of any of embodiments B1-B9, wherein the application is an extended reality (XR) application and the data generated by the application has a bounded latency requirement.
C1. A user equipment (UE) configured to transmit application data to a radio access network (RAN) node, the UE comprising:
   communication interface circuitry configured to communicate with the serving cells; and
   processing circuitry operatively coupled to the communication interface circuitry, whereby the processing circuitry and the communication interface circuitry are configured to perform operations corresponding to any of the methods of embodiments A1-A10.
C2. A user equipment (UE) configured to transmit application data to a radio access network (RAN) node, the UE being further configured to perform operations corresponding to any of the methods of embodiments A1-A10.
C3. A non-transitory, computer-readable medium storing computer-executable instructions that, when executed by processing circuitry of a user equipment (UE) configured to transmit application data to a radio access network (RAN) node, configure the UE to perform operations corresponding to any of the methods of embodiments A1-A10.
C4. A computer program product comprising computer-executable instructions that, when executed by processing circuitry of a user equipment (UE) configured to transmit application data to a radio access network (RAN) node, configure the UE to perform operations corresponding to any of the methods of embodiments A1-A10.
D1. A radio access network (RAN) node configured to receive application data from a user equipment (UE), the RAN node comprising:
   communication interface circuitry configured to communicate with the UE via the serving cells; and
   processing circuitry operatively coupled to the communication interface circuitry, whereby the processing circuitry and the communication interface circuitry are configured to perform operations corresponding to any of the methods of embodiments B1-B10.
D2. A radio access network (RAN) node configured to receive application data from a user equipment (UE), the RAN node being further configured to perform operations corresponding to any of the methods of embodiments B1-B10.
D3. A non-transitory, computer-readable medium storing computer-executable instructions that, when executed by processing circuitry of a radio access network (RAN) node configured to receive application data from a user equipment (UE), configure the RAN node to perform operations corresponding to any of the methods of embodiments B1-B10.
D4. A computer program product comprising computer-executable instructions that, when executed by processing circuitry of a radio access network (RAN) node configured to receive application data from a user equipment (UE), configure the RAN node to perform operations corresponding to any of the methods of embodiments B1-B10.

1.-36. (canceled)

37. A method for a user equipment (UE) configured to transmit application data to a radio access network (RAN) node, the method comprising:
buffering data generated by an application hosted by the UE, wherein the buffered data comprises a plurality of sets of protocol data units (PDUs); and
transmitting a buffer status report (BSR) to the RAN node in response to one or more of the following conditions at the UE:
at least one of the buffered PDU sets has a remaining packet delay budget (PDBᵣₑₘ) that is less than a first threshold, wherein PDBᵣₑₘ for a PDU set decreases in proportion to a duration that the PDU set has been buffered; and
at least one of the buffered PDU sets is discarded by the UE.

38. The method of claim 37, wherein the transmitted BSR indicates an amount of data corresponding to buffered PDU sets that meet the one or more conditions at the UE.

39. The method of claim 37, further comprising receiving a BSR configuration from the RAN node, wherein the BSR configuration includes a value for the first threshold

40. The method of claim 37, wherein buffering data comprises assigning each of the PDU sets, upon buffering, to one of a plurality of available PDB buckets associated with respective ranges of PDBᵣₑₘ.

41. The method of claim 40, wherein the first threshold corresponds to one or more PDB buckets that are associated with one or more lowest of the ranges of PDBᵣₑₘ.

42. The method of claim 40, wherein the BSR is also transmitted to the RAN node in response to any of the following conditions at the UE:
a number or total size of buffered PDU sets with PDBᵣₑₘ greater than a second threshold is at least a third threshold;
a number or total size of buffered PDU sets with PDBᵣₑₘ that change from greater than to less than a fourth threshold, is at least a fifth threshold;
a number or total size of buffered PDU sets that are overdue is at least an sixth threshold;
a number or total size of buffered PDU sets changes by at least a seventh threshold; and
an explicit indication received from the RAN node.

43. The method of claim 42, wherein:
the method further comprises adjusting the PDB bucket assignment of each of the PDUs that remains buffered after a time period, according to their respective PDBᵣₑₘ; and
the fourth threshold corresponds to a boundary between two PDB buckets associated with adjacent ranges of PDBᵣₑₘ.

44. The method of claim 41, wherein when the explicit indication is received from the RAN node, the BSR is transmitted to the RAN node even when no data generated by the application is currently buffered.

45. The method of claim 37, further comprising:
initiating a prohibit timer in association with transmitting the BSR; and
refraining from transmitting another BSR until expiration of the prohibit timer, even when one of the conditions occurs while the prohibit timer is running.

46. The method of claim 37, further comprising:
receiving from the RAN node a grant of uplink resources based on the transmitted BSR; and
transmitting at least a portion of the buffered data to the RAN node, using the granted uplink resources.

47. The method of claim 37, wherein the application is an extended reality (XR) application and the data generated by the application has a bounded latency requirement.

48. A method for a radio access network (RAN) node configured to receive application data from a user equipment (UE), the method comprising:
receiving from the UE a buffer status report (BSR) pertaining to buffered data generated by an application hosted by the UE, wherein:
the buffered data comprises a plurality of sets of protocol data units (PDUs); and
the BSR is received in response to one or more of the following conditions at the UE:
at least one of the buffered PDU sets has a remaining packet delay budget, PDBᵣₑₘ, that is less than a first threshold, wherein PDBᵣₑₘ for a PDU set decreases in proportion to a duration that the PDU set has been buffered; and
at least one of the buffered PDU sets is discarded by the UE.

49. The method of claim 48, wherein the received BSR indicates an amount of data corresponding to buffered PDU sets that meet the one or more conditions at the UE.

50. The method of claim 48, further comprising transmitting a BSR configuration to the UE, wherein the BSR configuration includes a value for the first threshold.

51. The method of claim 48, wherein each of the PDU sets is assigned by the UE, upon buffering, to one of a plurality of available PDB buckets associated with respective ranges of PDBᵣₑₘ.

52. The method of claim 51, wherein the first threshold associated corresponds to one or more PDB buckets that are associated with one or more lowest of the ranges of PDBᵣₑₘ.

53. The method of claim 51, wherein the BSR is also received from the UE in response any of the following conditions at the UE:
a number or total size of buffered PDU sets with PDBᵣₑₘ greater than a second threshold is at least a third threshold;
a number or total size of buffered PDU sets with PDBᵣₑₘ that change from greater than to less than a fourth threshold, is at least a fifth threshold;
a number or total size of buffered PDU sets that are overdue is at least an sixth threshold;
a number or total size of buffered PDU sets changes by at least a seventh threshold; and
an explicit indication received from the RAN node; and
an explicit indication sent by the RAN node.

54. The method of claim 53, wherein:
the PDB bucket assignments of the PDU sets that remain buffered after a time period are adjusted by the UE according to their respective PDBᵣₑₘ; and
the fourth threshold corresponds to a boundary between two PDB buckets associated with adjacent ranges of PDBᵣₑₘ.

55. The method of claim 53, wherein when the explicit indication is sent to the UE, the BSR is received from the UE even when no data generated by the application is currently buffered at the UE.

56. The method of claim 48, wherein after receiving the BSR, no further BSRs are received from the UE for at least a duration corresponding to a UE prohibit timer.

57. The method of claim 48, further comprising:
transmitting to the UE a grant of uplink resources based on the received BSR; and
receiving at least a portion of the buffered data from the UE, using the granted uplink resources.

58. The method of claim 48, wherein the application is an extended reality (XR) application and the data generated by the application has a bounded latency requirement.

59. User equipment (UE) configured to transmit application data to a radio access network (RAN) node, the UE comprising:
communication interface circuitry configured to communicate with the RAN node; and
processing circuitry operatively coupled to the communication interface circuitry, wherein the processing circuitry and the communication interface circuitry are configured to:
buffer data generated by an application hosted by the UE, wherein the buffered data comprises a plurality of sets of protocol data units (PDUs); and
transmit a buffer status report (BSR) to the RAN node in response to one or more of the following conditions at the UE:
at least one of the buffered PDU sets has a remaining packet delay budget, PDBᵣₑₘ, that is less than a first threshold, wherein PDBᵣₑₘ for a PDU set decreases in proportion to a duration that the PDU set has been buffered; and
at least one of the buffered PDU sets is discarded by the UE.

60. Radio access network (RAN) node configured to receive application data from a user equipment (UE), the RAN node comprising:
communication interface circuitry configured to communicate with the UE; and
processing circuitry operatively coupled to the communication interface circuitry, wherein the processing circuitry and the communication interface circuitry are configured to perform the method of claim 48.
